(19) United States
(12) Patent Application Publication
(10) Pub. No.: US 2013/0104602 A1
(43) Pub. Date: May 2, 2013

(54) METHOD FOR MANUFACTURING OBSCURED GLASS

(71) Applicants: SHYAN-JUH LIU, Tu-Cheng (TW); CHU-SHENG CHEN, Tu-Cheng (TW); XING-RONG XIAO, Shenzhen City (CN)

(72) Inventors: SHYAN-JUH LIU, Tu-Cheng (TW); CHU-SHENG CHEN, Tu-Cheng (TW); XING-RONG XIAO, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/446,239

(22) Filed: Apr. 13, 2012

(30) Foreign Application Priority Data
Nov. 2, 2011 (CN) 201110341321.4

(51) Int. Cl. C03C 21/00; C03C 19/00

(52) U.S. Cl. 65/30.14; 65/61

(57) ABSTRACT

A method for manufacturing obscured glass includes providing a glass substrate including a pre-obscured surface; applying a first harden process to the glass substrate to form a strength layer inward the pre-substrate surface; and applying a blasting process to the pre-obscured surface of the glass substrate to form an obscured layer inward the pre-obscured surface, wherein a thickness of the obscured layer is less than that of the strength layer.

### BACKGROUND

1. Technical Field

The present disclosure relates to methods for manufacturing glass, and more particularly to a method for manufacturing an obscured glass.

2. Description of Related Art

Methods for manufacturing obscured glass is mainly selected from one of blasting or chemical etching. In blasting process, an amount of injecting particles impact on an outer surface of a piece of glass to form an obscured layer. However, there is much cracks formed in a root segment of the obscured layer during the blasting process, thus the obscured glass obtains a low intensity and is easily damaged. In addition, in a chemical etching process, environment pollution can occur due to the hydrofluoric acid employed in the chemical etching process.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a flowchart of an embodiment of a method for manufacturing obscured glass.

FIG. 2 is a sectional view of a glass substrate after a first harden process.

FIG. 3 is a sectional view of the glass substrate of FIG. 2 after a blasting process.

FIG. 4 is an isometric view of the glass substrate of FIG. 2 during a rough burnish process.

FIG. 5 is a sectional view of the glass substrate of FIG. 2 after a second harden process.

### DETAILED DESCRIPTION

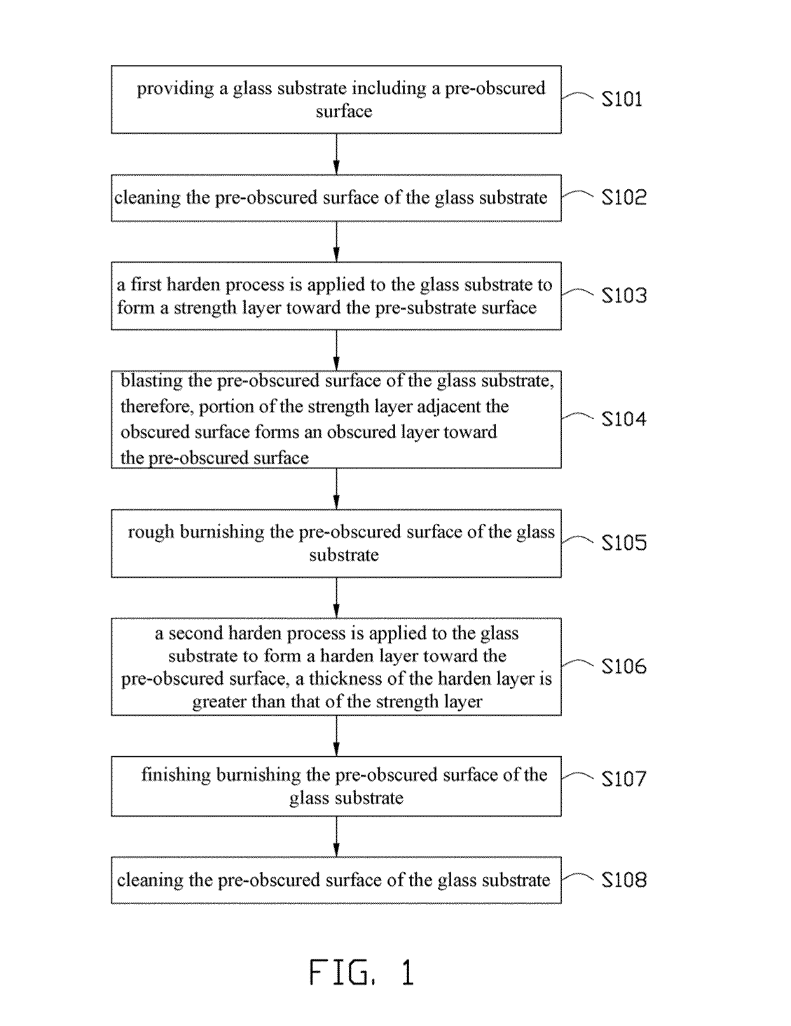

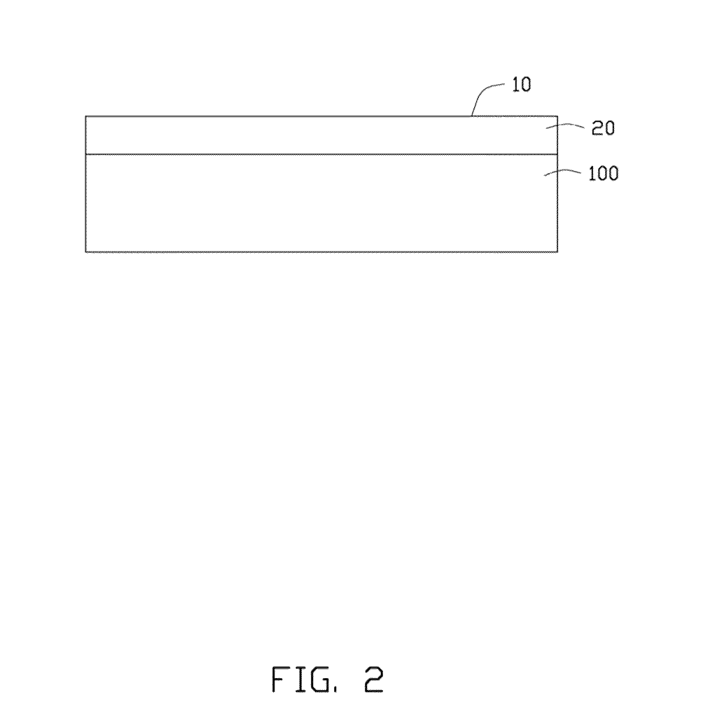

Referring to FIGS. 1 and 2, an embodiment of a method for manufacturing an obscured glass includes steps as follows:

In step S101: a glass substrate 100 is provided. The glass substrate 100 includes a pre-obscured surface 10.

In step S102: the pre-obscured surface 10 of the glass substrate 100 is cleaned. In the embodiment, an ultrasonic cleaning is applied to the glass substrate 100 to remove dust and ions from the pre-obscured surface 10.

In step S103: a first harden process is applied to the glass substrate 100, thereby forming a strength layer 20 toward the pre-substrate surface 10. The detail steps are illustrated as follow: first, an outer surface of the glass substrate 100 is shielded except the pre-obscured surface 10; secondly, the glass substrate 100 is immersed into molten potassium nitrate (KNO₃) for about 2 hours˜6 hours, wherein the temperature of the molten potassium nitrate is about 400 degrees ˜450 degrees Celsius, thereby the strength layer 20 extending toward the pre-obscured surface 10 is formed. A thickness of the strength layer 20 is about 8 μm˜30 μm, an intensity of the strength layer 20 is about 125 Mpa ˜350 Mpa; finally, the glass substrate 100 is taken out, a planarity of the pre-obscured surface 10 is about 10 μm ˜20 μm. Preferably, the immersion time of the glass substrate 100 immersed in the potassium nitrate is selected in a range of about 2 hours ˜4 hours, thereby the thickness of the strength layer is about 10 μm ˜30 μm and the intensity is about 300 Mpa. In the illustrated embodiment, the immersion time is about 3 hours and the thickness of the strength layer 20 is about 15 μm.

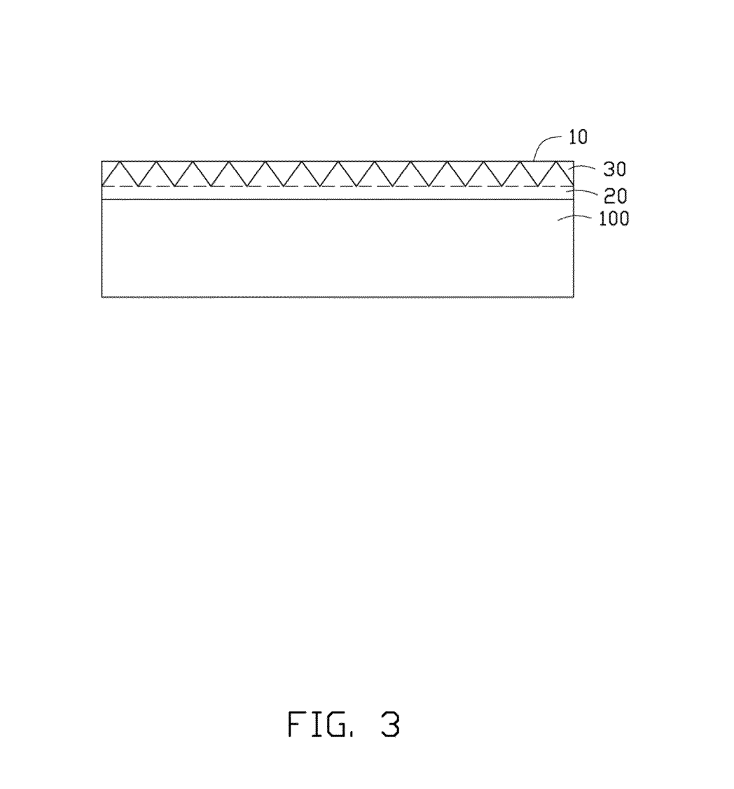

Referring to FIG. 3, in step S104: a blasting process is applied to the pre-obscured surface 10 of the glass substrate 100, therefore, portion of the strength layer 20 adjacent the obscured surface 10 forms an obscured layer 30 toward the pre-obscured surface 10. A thickness of the obscured layer 30 is less than that of the strength layer 20 in step S103. The injecting particles of the blasting process may select from brown aluminium oxide, white alundum, corundum or garnet sand with Mohs' scale between 8˜10. In the embodiment, a plurality of corundum with Mohs' scale 8˜10 is employed and the thickness of the obscured layer 30 is about 10 μm.

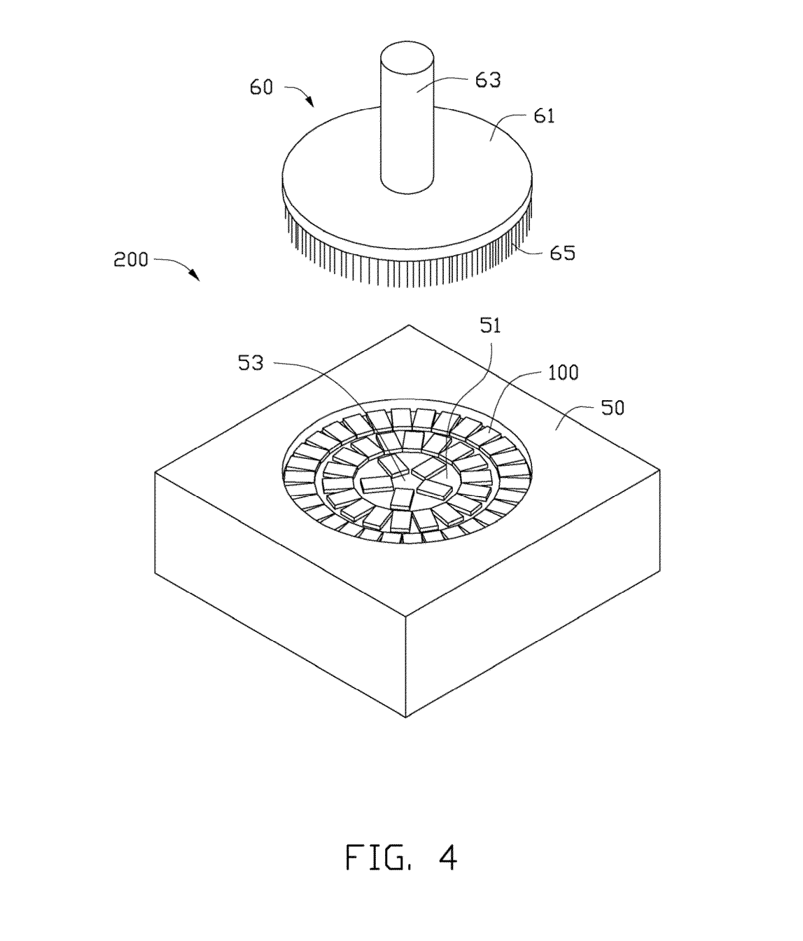

In step S105: a rough burnish process is applied to the pre-obscured surface 10 of the glass substrate 100. Referring to FIG. 4, firstly, a plurality of glass substrates 100 is arranged in a burnish device 200 after the blasting process; the burnish device 200 includes a support member 50, a burnish assembly 60, and a burnish cushion (not shown). The support member 50 is a rectangular block and defines a receiving chamber 51 at a top surface thereof. The support member 50 further defines a support surface 53 at the bottom of the receiving chamber 51 and a plurality of receiving grooves (not labeled) on the support surface 53. The receiving chamber 51 is cylindrical and the plurality of receiving grooves is radially arranged around the center of the support surface 53. The burnish assembly 60 includes a rotation plate 61 in a disc-shape, a driving shaft 63, and a brush 65. The driving shaft 63 and the brush 65 are connected to opposite ends of the rotation plate 61. The diameter of the rotation plate 61 is equal to that of the receiving chamber 51. The burnish cushion is received in the receiving chamber 51 and abuts against the support surface 53. The burnish cushion defines a plurality of mounting grooves (not labeled) corresponding to the plurality of the receiving grooves. The pre-obscured surface 10 of each glass substrate 100 is away from the support surface 53; secondly, a burnish solution is poured into the receiving chamber 51 of the support member 50; finally, the rotation plate 61 is driven by the driving shaft 63 to drives the brush 65 rotate, and the rotation plate 61 moves toward the glass substrate 100 and the drives the brush 65 burnish the pre-obscured surface 10. In the embodiment, the burnish solution is made of cerium oxide.

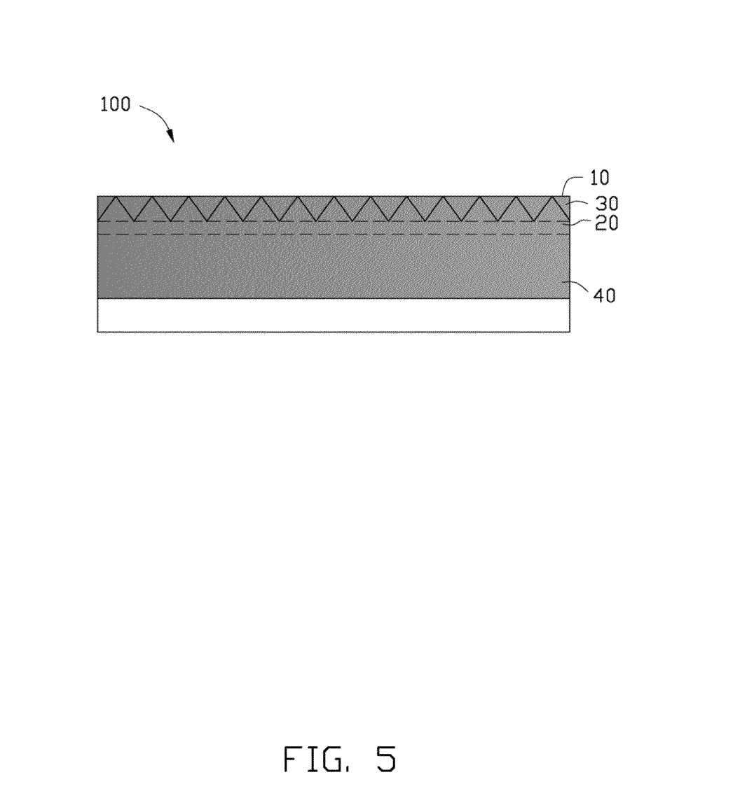

Referring to FIG. 5, in step S106: a second harden process is applied to the glass substrate 100, thereby forming a harden layer 40 inward the pre-obscured surface 10, a thickness of the harden layer 40 is greater than that of the strength layer 20 in step S103. First, an outer surface of the glass substrate 100 is shielded except the pre-obscured surface 10; secondly, the glass substrate 100 is immersed in molten KNO₃, the molten KNO₃ is about 400 degrees ˜450 degrees celsius, a harden layer 40 is formed on the pre-obscured surface 10 extending inward the pre-obscured surface 20, a thickness of the harden layer 40 is about 30 μm ˜50 μm and an intensity of the harden layer 40 is about 450 Mpa ˜780 Mpa; finally, the glass substrate 100 is taken out. Preferably, the immersion time is about 6 hours ˜8 hours, and the thickness of the harden layer 40 is about 30 μm ˜50 μm, the intensity of the harden layer 40 is about 600 Mpa˜730 Mpa. In the illustrated embodiment, the immersion time is 6 about hours, the thickness of the harden layer 40 is about 40 μm, and the intensity is about 600 Mpa.

In step S107: A finishing burnish process is applied to the pre-obscured surface 10 of the glass substrate 10. The steps of the finishing burnish process are same as that of the rough burnish process. The finishing burnish process is capable of removing dust and ions which adhesive on the glass substrate 100 during the afore-mentioned process. The time of the finishing burnish process is slightly shorter than that of the rough burnish process.

In step S108: the pre-obscured surface 10 of the glass substrate 10 is cleaned. First, the glass substrate 10 with water is washed; secondly, the glass substrate 10 is immersed in water for about 10 minutes ˜15 minutes; finally, the glass substrate 10 is cleaned in an ultrasonic cleaning process with abluent.

A first harden process is employed in the method for manufacturing obscured glass, such that the strength layer 20 is formed thereby toward the pre-obscured surface 10 to prevent cracks on the glass substrate 100 during the following blasting process, so the intensity of the obscured glass is improved. The hydrofluoric acid is omitted here, so the method for manufacturing obscured glass is more safety. Moreover, a harden layer 40 thicker than the strength layer 20 is formed there, thus an obscured glass of high and even intensity is obtained.

It should be noted that if the glass substrate 100 is clean enough, the cleaning process before the first harden process may be omitted. If the glass substrate 100 after the finishing burnish process is clean enough, the cleaning process thereafter may be omitted. When a relative large roughness the pre-obscured surface 10 satisfies the demand of the obscured glass, the rough burnish process, the second harden process, the finishing burnish process and the cleaning process thereafter may be omitted.

It should be noted that when the glass substrate 100 includes two pre-obscured surfaces 10 opposite to each other, the method is the same, during the first and the second harden processes, the shielding of the glass substrate 100 may be omitted and the glass substrate 100 is immersed in the molten potassium nitrate directly.

It should be noted that in the rough burnish process and the finishing burnish process, the burnish solution may be dilution of the cerium oxide, alumina, silicon oxide, chromic oxide, zirconium dioxide, carborundum and superfine corundum. The ultrasonic may be omitted in the two cleaning processes, and a driver is employed to drive water to flow to clean the glass substrate 100.

Finally, while various embodiments have been described and illustrated, the disclosure is not to be construed as being restricted thereto. Various modifications can be made to the embodiments by those skilled in the art without departing from the true spirit and scope of the disclosure as defined by the appended claims.

What is claimed is:

1. A method for manufacturing obscured glass, comprising:
(1) providing a glass substrate comprising a pre-obscured surface;
(2) a first harden process applied to the glass substrate to form a strength layer inward the pre-substrate surface; and
(3) blasting the pre-obscured surface of the glass substrate to form an obscured layer inward the pre-obscured surface, wherein a thickness of the obscured layer is less than that of the strength layer.

2. The method for manufacturing obscured glass of claim 1, further comprising cleaning the pre-obscured surface of the glass substrate between the steps (1) and (2).

3. The method for manufacturing obscured glass of claim 1, further comprising a step (4): rough burnishing the pre-obscured surface of the glass substrate after the step (3).

4. The method for manufacturing obscured glass of claim 3, wherein a period of the first harden process is selected in a range of about 2˜6 hours, an intensity of the strength layer is about 125˜350 Mpa and a thickness of the strength layer is about 1030 micrometers.

5. The method for manufacturing obscured glass of claim 3, further comprising a step (5): a second harden process applied to the glass substrate to form a harden layer inward the pre-obscured surface after the step (4), a thickness of the harden layer is greater than that of the strength layer,

6. The method for manufacturing obscured glass of claim 5, further comprising a step (6): finishing burnishing the pre-obscured surface of the glass substrate after the step (5), and a step (7): cleaning the pre-obscured surface of the glass substrate after the step (6).

7. The method for manufacturing obscured glass of claim 5, wherein in the first and the second harden processes, a molten potassium nitrate is employed to treat the pre-obscured surface of the glass substrate, a temperature of the molten potassium nitrate is about 400˜450 degrees Celsius.

8. The method for manufacturing obscured glass of claim 7, wherein in the second harden process, the glass substrate is immersed in the molten potassium nitrate for about 6˜8 hours, a thickness of the harden layer is about 30˜50 micrometers and the intensity of the harden layer is about 600˜730 Mpa.

9. The method for manufacturing obscured glass of claim 5, wherein the pre-obscured surface is an outer surface of the glass substrate, in the first and the second harden processes, the glass substrate being immersed in molten potassium nitrate totally.

10. The method for manufacturing obscured glass of claim 6, wherein the step (7) comprises steps as follows: firstly, washing the glass substrate with water; secondly, immersing the glass substrate in water for about 10˜15 minutes; finally, cleaning the glass substrate in an ultrasonic process with abluent.

11. A method for manufacturing obscured glass, comprising:
(1) providing a glass substrate comprising a pre-obscured surface, the pre-obscured surface being an outer surface thereof;
(2) applying a first harden process to the glass substrate to form a strength layer inward the pre-substrate surface;
(3) blasting the pre-obscured surface of the glass substrate to form an obscured layer inward the pre-obscured surface, wherein a thickness of the obscured layer is less than that of the strength layer in step (2); and
(4) applying a second harden process to the glass substrate to form a harden layer inward the pre-obscured surface, a thickness of the harden layer being greater than that of the strength layer in step (2).

12. The method for manufacturing obscured glass of claim 11, further comprising cleaning the pre-obscured surface of the glass substrate between the steps (1) and (2).

13. The method for manufacturing obscured glass of claim 11, further comprising rough burnishing the pre-obscured surface of the glass substrate between steps (3) and (4).

14. The method for manufacturing obscured glass of claim 13, wherein a period of the first harden process is about 2˜6 hours, an intensity of the strength layer is about 125˜350 Mpa and the thickness of the strength layer is about 10˜30 micrometers.

15. The method for manufacturing obscured glass of claim 13, further comprising a step (5): finishing burnishing the pre-obscured surface of the glass substrate after the step (4) and cleaning the pre-obscured surface of the glass substrate after the step (5).

16. The method for manufacturing obscured glass of claim 1, wherein in the first and the second harden processes, a molten potassium nitrate is employed to treat the pre-obscured surface of the glass substrate, and a temperature of the molten potassium nitrate is about 400 degrees˜450 degrees Celsius.

17. The method for manufacturing obscured glass of claim 16, wherein in the second harden process, the glass substrate is immersed in the potassium nitrate about 6˜8 hours, the thickness of the harden layer is about 30˜50 micrometers and the intensity of the harden layer is about 600 Mpa˜730 Mpa.
